(19) United States
(12) Patent Application Publication
(10) Pub. No.: US 2013/0144808 A1
(43) Pub. Date: Jun. 6, 2013

(54) IN-KIND DISTRIBUTION PROCESS FOR POOLED STABLE VALUE TRUST FUNDS

(71) Applicant: Jonathan Lee Mercier, Manchester, CT (US)

(72) Inventor: Jonathan Lee Mercier, Manchester, CT (US)

(21) Appl. No.: 13/691,660

(22) Filed: Nov. 30, 2012

Related U.S. Application Data
(60) Provisional application No. 61/567,614, filed on Dec. 6, 2011.

(51) Int. Cl. G06Q 40/06

(52) U.S. Cl. CPC G06Q 40/06
USPC 705/36 R

(57) ABSTRACT

A highly efficient method is created for making an in-kind distribution of a defined contribution plan's beneficial interest in the investment assets of a pooled stable value fund, including, but not limited to a stable value collective trust fund. This is done by creating a sub-account within the insurer's, or other wrap provider's, separate account and allocating a pro rata share of the fund's investment assets to the sub account. The sub account is then wrapped by a pre-agreed version of the wrap provider's guarantee contract it would issue directly to a plan. Satisfying a plan withdrawal request in this manner would, among other things, mitigate the wrap provider's risk by eliminating the need to make a cash book value payments after a brief notice or “put” period.

### CROSS-REFERENCE TO RELATED APPLICATION

This application claims the benefit of priority of U.S. provisional application No. 61/567,614, filed Dec. 6, 2011, the contents of which are herein incorporated by reference.

### BACKGROUND OF THE INVENTION

The present invention relates to investment vehicles and, more particularly, to an in-kind distribution process that that avoids the need to liquidate assets at a loss in order to make payments at the end of a one-year put period.

Pooled stable value investment funds and trusts (“Trusts”) serve as a fixed interest option for participating defined contribution pension plans (“Plans”). Trusts invest in bonds and other fixed income investments that can be carried at book value through the employment of “book value wrap contracts” (“Wraps”). When a qualified plan withdraws from a Trust, the distribution typically must be made within a specified period, commonly one year (the “Put Period”). This requirement exposes the Wrap provider to certain actuarial and financial risks for which is charges a higher Wrap fee and otherwise restricts the investments the Trust may make.

Stable value collective trusts are a specific type of bank sponsored Trust (“Collective Trusts”) which require a book value guarantee from a bank or insurer. Currently, such guarantees can be difficult to obtain and often impose restrictive investment terms. This is due to the requirement that a bank sponsering a Collective Trust (the “Trustee”) fully honor all withdrawal requests at book value within the Put Period, creating an unacceptable level of risk for the guarantee provider.

The major benefit of stable value funds is a high stable and positive return. This is achieved by investing in longer duration investments that are held at book value due to the presence of the guarantee. In other contexts, such as when issuing a Wrap to a single Plan's stable value fund, to mitigate its guarantee risk, the guarantee provider typically requires that full withdrawals be paid over the investment duration of the supporting assets. In such situations, if a lump sum option is available, its amount will never exceed the current market value of the supporting assets.

The “one-year put” requirement for Collective Trusts precludes any direct application of such a requirement.

Withdrawal requests from a Collective Trust can be satisfied by an in-kind distribution. However, current methods for effecting an in-kind distribution are cumbersome, time-consuming and expensive. Typically, in-kind distributions are practical only when the stable value assets being distributed are well in excess of $500 million.

Currently, an in-kind distribution from a Collective Trust involves a number of complex steps. The Trustee must select the whole assets to be included in the distribution. Detailed legal negotiations are needed between the Trustee, the Plan, and the guarantee provider. Legal title to the selected assets must be transferred to the Plan's designated custodian. For these reasons, an in-kind distribution is rarely used and then only for the largest distributions.

One option for Collective Trusts is to reduce investment duration. However, reducing investment duration suppresses yield available to Plan participants, substantially reducing the primary benefit of a stable value fund. As discussed above, in-kind distributions are currently rarely used, as they are costly and inefficient, typically requiring the establishment of a separate trust and entailing extensive, complex multiparty negotiations.

Trusts can also be established by other entities (“Sponsors”) that pool the stable value assets of multiple Plans (“Pooled Trusts”). Examples of Pooled Trusts include stable value funds sponsored by labor organizations (for Plans covering their members); professional organizations (for plans established for its members' firms) and State governmental plans (for plans covering participating municipalities and similar government entities). While Pooled Trusts are not subject to an explicit Put Period requirement, they often permit Plans to withdraw from the Pooled Trust on terms that create similar actuarial and financial risks for guarantee providers.

As can be seen, there is a need for a method for making in-kind distributions from a stable value Trust.

### SUMMARY OF THE INVENTION

In one aspect of the present invention, a method for effecting an in-kind distribution from a Trust, comprises establishing relationship between a Trustee or Sponsor and a wrap provider; reaching an agreement between the Trustee or Sponsor and the wrap provider with respect to a guarantee contract issued to the Trust and to a clone Wrap contract issued in conjunction with an in-kind distribution; receiving a notification from a Plan by the Trustee or Sponsor of its intent to withdraw from the Collective or Pooled Trust; agreeing on an in-kind distribution date; establishing a sub-account and allocating investment assets to the sub-account on a purely pro rata basis; and issuing the clone contract to the Plan receiving the in-kind distribution.

In another aspect of the present invention, a method for effecting an in-kind distribution from a Trust comprises establishing relationship between a Trustee or Sponsor and a Wrap provider that is an insurer; reaching an agreement between the Trustee or Sponsor and the insurer with respect to a guarantee contract issued to the Trust and to a clone Wrap contract issued in conjunction with an in-kind distribution; receiving a notification from a plan by the Trustee or Sponsor of its intent to withdraw from the Trust; agreeing on an in-kind distribution date; establishing a sub-account and allocating investment assets to the sub-account on a purely pro rata basis; issuing the clone contract to the Plan receiving the in-kind distribution; investing all sub-account cash flows independently from assets of the Trust; and electing to terminate the clone contract and electing a distribution mode.

These and other features, aspects and advantages of the present invention will become better understood with reference to the following drawings, description and claims.

### BRIEF DESCRIPTION OF THE DRAWINGS

FIG. 1 is a process diagram of a Trust before installation of the process of the present invention;

FIG. 2 is a process diagram of a Trust after installation of the process of the present invention;

FIG. 3 is a process diagram illustrating the operation of the process of the present invention after an in-kind distribution; and

FIG. 4 is a functional process diagram illustrating the process for effecting an in-kind distribution according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a separate account to create a highly efficient method for satisfying withdrawal requests with an in-kind distribution of a beneficial interest of the trust fund's investment assets. This is done by creating a sub-account within the insurer's separate account and allocating a pro rata share of the trust's investment assets to the sub account. The sub account is then wrapped by a pre-agreed version of the insurer's Wrap, reflecting the contract terms it would include in any Wrap it would issue directly to a Plan. This clone Wrap contract would mitigate the insurer's risk by limiting the Plan's termination options to an immediate market value lump sum or book value payments over the duration of the supporting investments.

The clone Wrap can be substantially similar to the Wrap the insurer would typically issue directly to a Plan or it could be a truncated version of such a Wrap, limited to the discontinuance provisions and other key terms. Such a truncated version typically would be used where a Plan has indicated an intent to promptly terminate the clone Wrap contract, electing either a market value lump sum or a book value payout over a term of years, as defined in the clone Wrap contract.

In addition, if agreed to by the Plan, the clone Wrap contract can include any terms or provisions the Wrap provider typically is willing to include in a contract issued to a Plan. This could include, when the wrap provider is an insurer, a transfer of a market value lump sum to the insurer's general account and its issuance of a guaranteed interest contract (a “GIC”) reflecting the plan's book value interest in the Trust.

By providing an efficient in-kind distribution process, the present invention avoids the need to liquidate assets at a loss in order to make payments at the end of the Put Period. Under the terms of a “clone” Wrap contract that is included as part of the in-kind distribution, the Plan receiving the distribution continues to hold the clone Wrap contract or may elect to be paid out either at market value or over the remaining duration of the distributed investment assets.

Ideally, the process of the present invention would result in the sub-account having all of the Plan's interest in the Trust's assets. However, this feature is not required. When this feature is not present, the plan is likely to receive a combination of a cash (from other Trust assets) and the described in-kind distribution. In this event, the Plan may, with the insurer's consent, deposit the cash received into the sub-account as new cash flow to be invested.

The process of the present invention requires 1) the necessary legal authority and documentation to support an in-kind distribution; and 2) the Wrap provider's ability, in conjunction with any investment manager, to create, account for and report on each sub-portfolio independently from the Trust and its portfolio.

While the system of the present invention is designed for plan initiated withdrawals from stable value Trusts, essentially without modification, the same process can be used when a Trust elects to terminate its operation and distribute all of its assets. The only change is that the distribution process would be initiated by the Trust.

Many Trusts have multiple Wrap providers. It is not necessary for all Wrap providers to utilize the process of the present invention. Those that do not would make book value cash distributions within the Put Period. Trust in-kind distributions typically include a cash component. When multiple Wrap providers are present, if desired, it is possible to combine an in-kind distribution within multiple “market value book-ins” to consolidate all of a withdrawing plan's distribution with a single Wrap provider. A “market value book-in” is an accepted process whereby a Wrap provider agrees to accept a plan's market value distribution, while crediting the plan's prior book value balance. As part of such an arrangement, the Wrap provider will credit an adjusted interest rate to Plan participants' account balances.

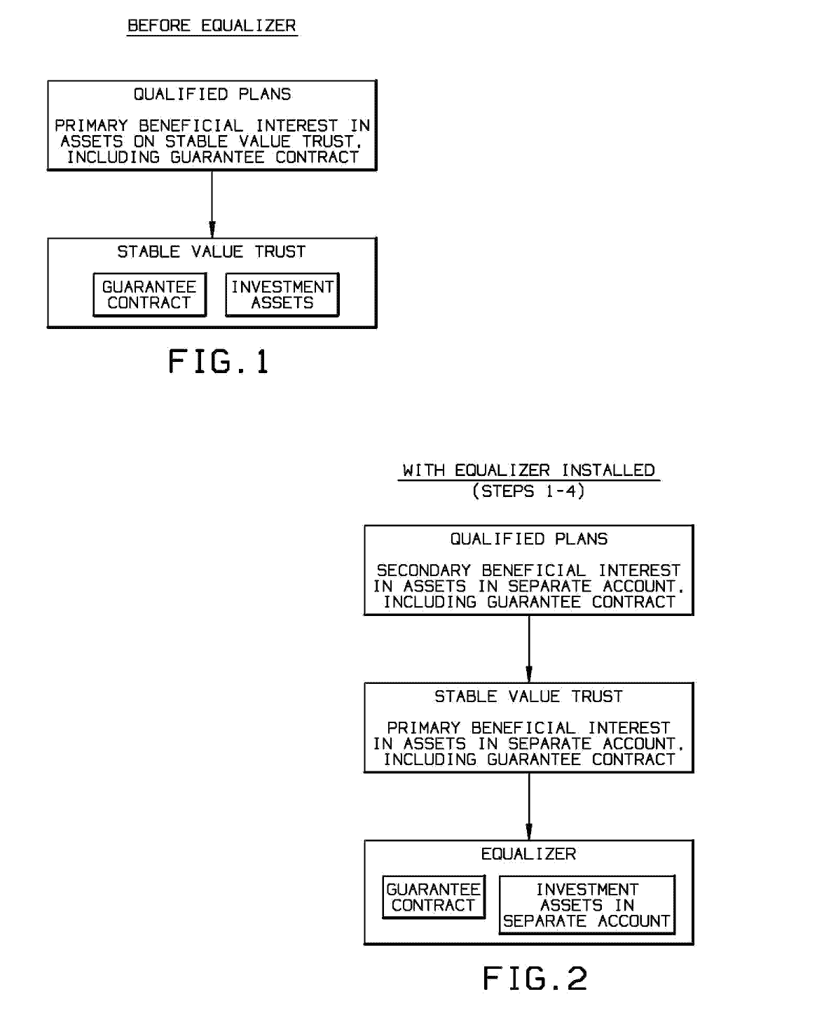

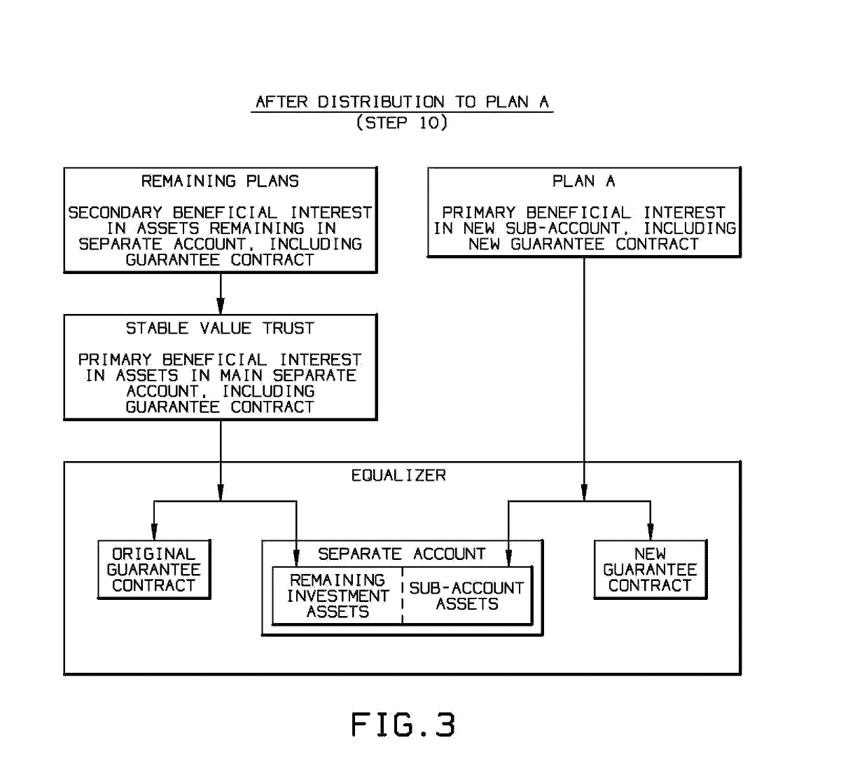

Referring to FIGS. 1 through 3, relationships among parties (qualified plans, Trust and the “equalizer”—the term to describe the process of the present invention) is shown without the present invention (FIG. 1), and with the present invention (FIG. 2), and then with the present invention after an in-kind distribution (FIG. 3).

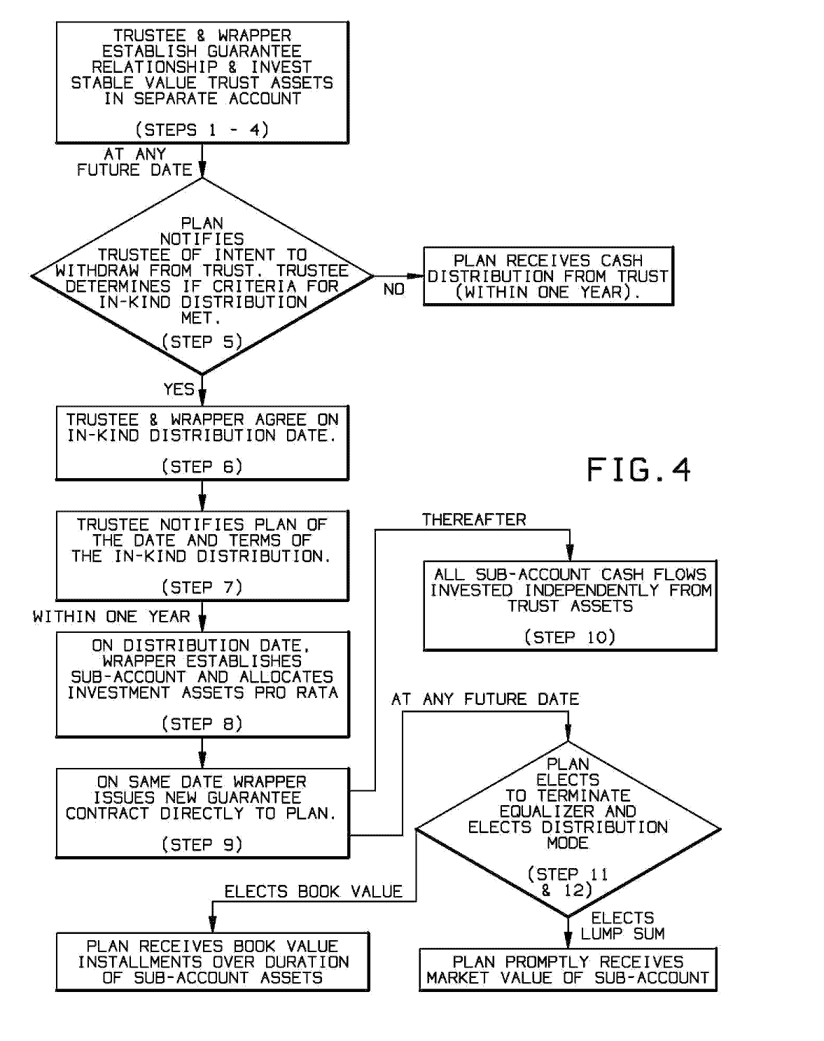

Referring to FIG. 4, a process for making in-kind distributions, according to an exemplary embodiment of the present invention, is shown. Steps 1-4 may occur when the Trustee and the insurer first establish the guarantee relationship. Here the Collective Trust assets are invested in a separate account. Steps 4 and 5 describe what occurs when a Plan elects to withdraw. Here, the Plan may notify the Trustee of the intent to withdraw from the Collective Trust and the Trustee may determine if the criteria for an in-kind distribution are met. If the criteria are not met, the Plan may receive a cash distribution from the Collective Trust (within one year). If the criteria are met, then the Trustee and insurer agree on an in-kind distribution date and the Trustee notifies the plan of the date and terms of the in-kind distribution.

Within one year of step 5, on the distribution date, the insurer may establish sub-account(s) and allocate investment assets pro rata thereto. Also on the distribution date, the insurer issues a new Wrap contract directly to the Plan. Thereafter, all sub-account cash flows are invested independently from the Collective Trust assets. At any future date, if the Plan elects to terminate the clone Wrap contract and distribute the assets, the Plan may elect a lump sum option or a book value option. With the lump sum option, the Plan promptly receives the market value of the sub-account. With the book value option, the Plan receives book value installments over the investment duration of the sub-account.

The length of time of this phase (until the Plan elects to terminate the clone Wrap contract and distribute the assets) can be highly variable. If the Plan elects to keep assets under the Wrap contract, it could be an essentially permanent relationship. If it promptly elects to terminate the relationship, it would only last until the appropriate payment or payments are made—over the investment duration if book value payments are elected and essentially immediately if a market value lump sum is elected.

With the process of the present invention (the “Equalizer process”), both legal title and asset custody remain with the insurer within its separate sub-account. As a result, the distribution can be a simple pro rata share of all of the Trust's assets on the distribution date. In effect, there is an accounting transfer of those assets (and their cash flows) to the new sub-account. While legal title remains with the insurer, the beneficial interest in those assets has been transferred from the Trust to the Plan. By agreeing on the form of the clone Wrap contract when first establishing the guarantee relationship between the Collective Trust and the insurer, it is not necessary to negotiate those terms in conjunction with the actual distribution. It should be noted that multiple Pans can have an interest in a sub-account, provided that they have substantially the same distribution date.

The availability of a simplified in-kind distribution process allows the insurer to substantially mitigate the financial risk associated with the Collective Trust one-year put requirement. This is because it will no longer be necessary to liquidate investment assets prior to maturity in order to satisfy most plan withdrawal requests. This reduced risk profile means that longer duration investments can be permitted in the Trust, thus increasing the potential investment yield to the Collective Trust.

While the primary focus of the invention is the protection of the Wrap providers from certain actuarial and financial risks when the market value of the supporting assets is below the Trust's book value, the invention can also be beneficially used when market value exceeds book value. In this mode, the invention can allow the withdrawing Plan to preserve its implicit investment gain while still transferring its stable value assets to a successor stable value funding vehicle. The operation of the invention is identical, regardless of the relationship between book and market value.

The process of the present invention provides a means of quickly and efficiently making an in-kind distribution without the need to identify specific assets to be transferred or the need to sell or otherwise liquidate specific assets. It works best with an insurance company separate account, but can be adapted to other forms of commingled asset ownership. The creation of the Sub-Portfolio should be an merely accounting transaction, with no change in legal title. Once the Sub-Portfolio is created, it operates independently from the Trust and from the main Portfolio, simply receiving its pro rata share of income and maturity proceeds. When a plan elects to terminate the guarantee arrangement with the Wrap provider, under the terms of the guarantee contract, it must elect to take its funds under the terms the Wrap provider offers to directly underwritten plans (e.g., no Put provisions). Typically the plan could elect either an immediate market value lump sum or book value installments over the approximate duration of the Sub-Portfolio's investments.

In would be possible to substitute a master trust or a master custody agreement for the insurance company separate account. This would, among other things, allow a bank that provides a stable value guarantee to utilize the process of the present invention. It would also be possible to have a similar process with a fixed maturity insurer contract, as are typically issued out of an insurer's general account (e.g., a GIC).

The below offers examples how the Equalizer process can be used. The below are merely examples and other processes and variations are within the scope of the present invention as defined by the claims.

| | Book Value | Market Value | MV:BV |
|---|---|---|---|
| | (in millions) | (in millions) | Ratio |
| Insurer A | $2.00 | $1.910 | 95.50% |
| Insurer B | $2.50 | $2.413 | 96.50% |
| Insurer C | $2.50 | $2.437 | 97.50% |
| Insurer D | $3.00 | $2.955 | 98.50% |
| Other Investments | $5.00 | $4.840 | 96.80% |
| TOTAL: | $15.00 | $14.555 | 97.00% |

With respect to the Table above, the below can be used to illustrate how an Equalizer multi-insurer in-kind distribution could work, based on common facts and differing approaches to the distribution process. Three distribution approaches are illustrated, the basic case and two optional cases.

A plan with $15 million invested in a stable value collective trust requests a total distribution of its interest in the trust. At the time of the request, two-thirds of the trust assets are invested in four Equalizer-enabled insurance issued Wraps. The overall fund has a market:book ratio of 97.00%. A contract-by-contract breakdown is shown in the Table above.

In each of the illustrated cases, one or more of the insurers issues a clone Wrap contract to the Plan, supported by the assets in its separate account. In addition, in the two optional cases, a selected insurer would “book-in” additional cash market value distributions into its separate account.

The clone Wrap contract would, in each case, reflect the standard terms of the stable value contract that insurer would issue in a direct sale to a qualified plan. In particular, the cash-out terms would include the ability either to take a lump sum, market value distribution or to receive the contract's book value over a period reflective of the duration of the assets in the insurer's separate account.

In the base case, each Equalizer-enabled insurer effects an in-kind distribution of a clone Wrap contract reflecting the Plan's pro-rata interest in the contract the insurer issued to the collective trust. Non-Equalizer amounts are paid in cash at book value, subject to the trust's one-year put.

The Plan would receive a distinct Wrap contract from each insurer reflecting its specific market and book value, as reflected in the above table. In the aggregate, the four contracts would reflect $10.00 million in book value and $9.715 million in market value, for a MV:BV ratio of 97.15%. In addition, the Plan would receive $5.00 million, plus interest, in cash in approximately one year from the date of its request. These funds could be invested in any manner selected by the Plan, including being deposited into one or more of the insurers' Wrap contracts.

The base case reflects a direct application of the Equalizer concept to the distribution process. Subject only to the terms of its agreement with the insurers, this distribution can be implemented unilaterally by the Trustee under the terms of its trust.

In a first optional case, all Equalizer-enabled assets are distributed through a single, selected insurer's stable value Wrap contract. The selected insurer would effect a standard Equalizer in-kind distribution of amounts already in its separate account. In addition, the selected insurer would accept into its separate account, in cash, the market value of the other three insurer contracts. In a standard “book-in” transaction, the insurer would add the book value or those contracts to the prior book value of its contract. Non-Equalizer amounts would be paid in cash at book value, subject to the Trust's one-year Put Period.

Assuming Insurer C was the selected insurer, it would issue its standard plan Wrap contract reflecting its $2.50 million of book value and $2.437 million of market value. At the same time, it would accept $7.278 million in cash from the other three insurers, crediting an additional book value of $7.50 million. After the transaction is complete, Insurer C's contract would reflect $10.00 million in book value and $9.715 million in market value, for a market value:book value ratio of 97.15%, a result identical to that in the base case. In addition, the Plan would receive $5.00 million, plus interest, in cash in approximately one year from the date of its distribution request. This amount could be invested in Insurer C's contract or in any other manner selected by the Plan.

In a second optional case, the entire distribution would be managed as an in-kind distribution through the stable value Wrap contract of a single insurer. The selected insurer would effect a standard Equalizer in-kind distribution of amounts already in its separate account. In addition, the selected insurer would accept, in cash, the market value of the other three insurers' contracts, plus the market value of the remaining assets available for immediate distribution.

Again, assuming Insurer C was the selected insurer, it would issue its standard stable value contract reflecting its $2.50 million of book value and $2.437 of market value. At the same time, it would accept $7.278 million in cash from the other three insurers, plus $4.840 million in additional assets, for a total cash deposit of $12.118 million. In the “book-in” transaction, Insurer C would credit an additional $12.50 million to the book value of its new Wrap contract.

After the transaction is complete, Insurer C's contract would reflect $15.00 million in book value and $14.555 million in market value, for a market value:book value ratio of 97.00%, a result substantially reflecting the Plan's position in the Collective Trust prior to the in-kind distribution.

In summary, the base case reflects the direct application of the Equalizer concept. The two optional cases reflect alternative approaches that may be preferable in some circumstances. In all three cases, the form of the distribution does not materially alter the Plan's financial position.

The below example provides a simplified illustration of how Equalizer in-kind distributions might be used to facilitate the termination of a Pooled Trust. A Pooled Trust has determined that it will discontinue its operations, making termination distributions to its participating Plans. The Trust has $1.2 billion invested in its stable value Trust fund. The Trust has four wrap providers, two of which have Equalizer enabled insurance contracts. The overall fund has a market:book ratio of 98.30%. The chart below shows a contract-by-contract breakdown:

| | Book Value | Market Value | MV:BV |
|---|---|---|---|
| | (in millions) | (in millions) | Ratio |
| Wrapper A (with Equalizer) | $250.0 | $245.0 | 98.00% |
| Wrapper B (with Equalizer) | $300.0 | $291.0 | 97.00% |
| Wrapper C | $200.0 | $196.0 | 98.00% |
| Wrapper D | $250.0 | $247.5 | 99.00% |
| Cash (and other short-term | $200.0 | $200.0 | 100.00% |
| investments) | | | |
| TOTAL: | $1,200.0 | $1,179.5 | 98.30% |

In a first illustrative case, the Pooled Trust has ten participating Plans, each with a total of a $120 million interest in the stable value fund. The two Equalizer-enabled wrappers each agree to accept five of the ten Plans as their direct customers. Each Plan receives a $20 million cash termination distribution and a clone Wrap contract reflecting an in-kind distribution of its pro-rata interest in the Pooled Trust.

Plans receiving a clone Wrap contract from Wrapper A receive an Equalizer in-kind distribution of approximately $25 million. In addition, Wrapper A accepts a market value payment from the assets wrapped by the other wrappers of approximately $73.5 million, crediting a book-in value of $75 million. With the cash distribution, each Plan retains the $120 million of book value it had in the Pooled Trust.

Plans receiving a clone Wrap contract from Wrapper B receive a comparable termination distribution, consisting of an Equalizer in-kind distribution of $30 million; a book-in with a market value of $68.9 million and a book value of $70 million; and a cash distribution of $20 million.

A second illustrative case has the same facts as the first case, except the Pooled Trust has five Plans with $120 million each of stable value assets; twenty-five Plans with $20 million each of stable value assets and 150 Plans with less than $1 million in assets. The assets of the 150 small Plans total $100 million.

Wrapper A agrees to issue clone Wrap contracts to the five largest Plans and wrapper B agrees to issue clone Wrap contracts to the next twenty-five Plans. However both wrappers have a strict underwriting limit prohibiting them from issuing contracts to Plans with less than $1 million.

The Pooled Trust elects to pay all of the 150 small Plans immediate cash termination distributions, totaling $100 million, reflecting their total interest in the Pooled Trust. The five largest plans each receive a cash termination distribution of approximately $10.9 million Plus a clone Wrap contract from Wrapper A consisting of an Equalizer in-kind distribution of $50 million and a book-in to Wrapper A's clone contract, with a market value of approximately $57.9 million and a book value of approximately $59.1 million. The remaining twenty-five Plans each receive immediate cash termination distributions of approximately $1.8 million plus a clone Wrap contract from Wrapper B consisting of an Equalizer in-kind distribution of $12 million and a book-in to their contract with a market value of approximately $6.1 million and a book value of approximately $6.2 million.

In summary, in both cases, the participating Plans receive a termination distribution that fully maintains the book value of their stable value assets.

It should be understood, of course, that the foregoing relates to exemplary embodiments of the invention and that modifications may be made without departing from the spirit and scope of the invention as set forth in the following claims.

What is claimed is:

1. A method for effecting an in-kind distribution from a stable value trust, comprising:
establishing relationship between a trustee and one or more wrap contract providers;
reaching an agreement between the trustee and the wrap contract provider with respect to a guarantee contract issued to the stable value trust and to a clone contract issued in conjunction with a distribution;
receiving a notification from a plan by the trustee of its intent to withdraw from the stable value trust;
agreeing on an in-kind distribution date;
establishing a sub-account and allocating investment assets to the sub-account on a pro rata basis; and
issuing the clone contract to the plan receiving the distribution.

2. The method of claim 1, wherein the wrap contract provider is an insurer.

3. The method of claim 1, wherein the trustee is a bank.

4. The method of claim 1, wherein the stable value trust is a collective trust.

5. The method of claim 1, wherein the distribution is initiated by the Trustee.

6. The method of claim 1, wherein the establishing of the sub-accounting and the allocating investment assets to the sub-account is done within a put period.

7. The method of claim 6, wherein the put period is one year.

8. The method of claim 1, further comprising investing all sub-account cash flows independently from assets of the collective trust.

9. The method of claim 1, further comprising electing to terminate the clone contract and electing a distribution mode.

10. The method of claim 9, wherein when the plan elects book value, the plan receives book value installments over a duration of assets in the sub-account.

11. The method of claim 9, wherein the plan elects a lump sum and the plan receives market value of the sub-account.

12. The method of claim 1, wherein establishing the sub-account does not change legal title thereto.

13. A method for effecting an in-kind distribution from a collective trust, comprising:
establishing relationship between a bank and one or more insurers;
reaching an agreement between the bank and the insurers with respect to a guarantee contract issued to the collective trust and to a clone contract issued in conjunction with a distribution;
receiving a notification from a plan by the bank of its intent to withdraw from the collective trust;
agreeing on an in-kind distribution date;
establishing a sub-account and allocating investment assets to the sub-account on a pro rata basis;
issuing the clone contract to the plan receiving the distribution;
investing all sub-account cash flows independently from assets of the collective trust; and
electing to terminate the clone contract and electing a distribution mode.

14. The method of claim 13, wherein when the plan elects book value, the plan receives book value installments over a duration of assets in the sub-account.

15. The method of claim 13, wherein the plan elects a lump sum and the plan receives market value of the sub-account.

16. The method of claim 13, wherein the establishing of the sub-accounting and the allocating investment assets to the sub-account is done within a put period.

17. The method of claim 13, wherein establishing the sub-account does not change legal title thereto.

18. The method of claim 13, wherein the distribution is initiated by the Trustee.
